(19) United States
(12) Patent Application Publication
(10) Pub. No.: US 2009/0158177 A1
(43) Pub. Date: Jun. 18, 2009

(54) SYSTEM AND METHOD FOR GENERATING A DATA ENTRY DISPLAY

(76) Inventors: Marianne L. Kodimer, Huntington Beach, CA (US); Silvy Wilson, Rancho Santa Margarita, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/956,762

(22) Filed: Dec. 14, 2007

(51) Int. Cl. G06F 3/048

(52) U.S. Cl. 715/762

(57) ABSTRACT

The subject application is directed to a system and method for generating a data entry display. Data entry template data is first retrieved from an associated data storage. Next, a data entry template is generated on an associated display in accordance with the retrieved template data, with the template having at least one data entry field adapted to receive user-specified information. Each data entry field is then designated as an active field. A prompt is generated on the associated display relating to content associated with each active field, and an animation is generated on an area associated with each active field. User-specified information is then received into each active field. Each active field is then updated such that user-specified information is displayed on the associated display.

### BACKGROUND OF THE INVENTION

The subject application is directed generally to improved data entry for electronic documents. It is particularly suited to enhance ease and accuracy with data entry in document processing kiosk environments, such as greeting card kiosks employing a touch screen interface. However, it is to be appreciated that the subject system is advantageously employed in any system in which various data entry fields are sequentially used for receipt of user-specified information.

Electronic documents are frequently created as templates for use in easily and quickly generating customized variations, wherein information is displayed in a preset form or format. Templates are used in connection with applications running on computer systems, such as personal computers, handheld computers, or shared devices, such as computer-based kiosks. One representative application of template usage is in connection with generation of customized greeting cards.

Greeting card kiosks are typically placed in public places. A user, typically for a fee, is able to select one of many greeting card templates in accordance with a particular occasion. Templates will include areas wherein a user can input customized content, such as text or graphic elements. Once a template has been customized by a user, a tangible output is made with an associated printer.

Many users, particularly with walk-up kiosks, are unsophisticated or unfamiliar with the particular system that they are using. This situation is exacerbated insofar as the devices are frequently located in busy, noisy locations, and there may be a queue of observers or others waiting for use of a device that will increase opportunities for error in customization. Errors in data entry or placement during creation may result in a device being tied up for longer periods of time, as well as subjecting users to additional cost and frustration from mistakes made.

### SUMMARY OF THE INVENTION

In accordance with one embodiment of the subject application, there is provided a system and method for improved data entry for electronic documents.

Further, in accordance with one embodiment of the subject application, there is provided a system and method for enhancing ease and accuracy with data entry in document processing kiosk environments, such as greeting card kiosks employing a touch screen interface.

Still further, in accordance with one embodiment of the subject application, there is provided a system and method wherein various data entry fields are sequentially used for receipt of user-specified information.

Further, in accordance with one embodiment of the subject application, there is provided a system for generating a data entry display. The system comprises means adapted for retrieving data entry template data from an associated data storage. The system also comprises template display means adapted for commencing generation of a data entry template on an associated display in accordance with retrieved template data, the data entry template having at least one data entry field adapted to receive user-specified information. The system further includes designating means adapted for designating each data entry field as an active field, means adapted for generating a prompt on the associated display relative to content associated with each active field, and animation means adapted for generating an animation on an area associated with each active field. The system also includes means adapted for receiving user-specified information into each active field and means adapted for updating each active field such that user-specified information is displayed therein on the associated display.

In one embodiment of the subject application, the designating means includes sequencing means adapted for sequentially designating each data entry field as an active field. According to such an embodiment of the subject application, the animation means includes means adapted for generating the animation on a border area associated with each active field. In another embodiment of the subject application, the template display means includes means adapted for generating a static border area on each inactive field, which static border area becomes animated when its corresponding field is designated active by the sequencing means. Preferably, the border display is comprised of a perimeter formed as dashes, wherein positions of the dashes are periodically altered relative to each active field.

In another embodiment of the subject application, the system includes means adapted for prompting operation of the sequencing means in accordance with received user input.

In yet another embodiment of the subject application, the system further includes means adapted for altering a pattern of sequencing by the sequencing means in accordance with received user input.

Still further, in accordance with one embodiment of the subject application, there is provided a method for generating a data entry display in accordance with the system as set forth above.

Still other advantages, aspects, and features of the subject application will become readily apparent to those skilled in the art from the following description, wherein there is shown and described a preferred embodiment of the subject application, simply by way of illustration, of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for generating a data entry display according to one embodiment of the subject application;

FIG. 2 is a block diagram illustrating device hardware for use in the system for generating a data entry display according to one embodiment of the subject application;

FIG. 3 is a functional diagram illustrating the device for use in the system for generating a data entry display according to one embodiment of the subject application;

FIG. 4 is a block diagram illustrating controller hardware for use in the system for generating a data entry display according to one embodiment of the subject application;

FIG. 5 is a functional diagram illustrating the controller for use in the system for generating a data entry display according to one embodiment of the subject application;

FIG. 6 is a flowchart illustrating a method for generating a data entry display according to one embodiment of the subject application;

FIG. 7 is a flowchart illustrating a method for generating a data entry display according to one embodiment of the subject application;

FIG. 8 is an example screen shot depicting a graphical user interface for use in the system and method for generating a data entry display according to one embodiment of the subject application; and

FIG. 9 is another example screen shot depicting a graphical user interface for use in the system and method for generating a data entry display according to one embodiment of the subject application.

### DETAILED DESCRIPTION OF THE PREFERRED EMBODIMENT

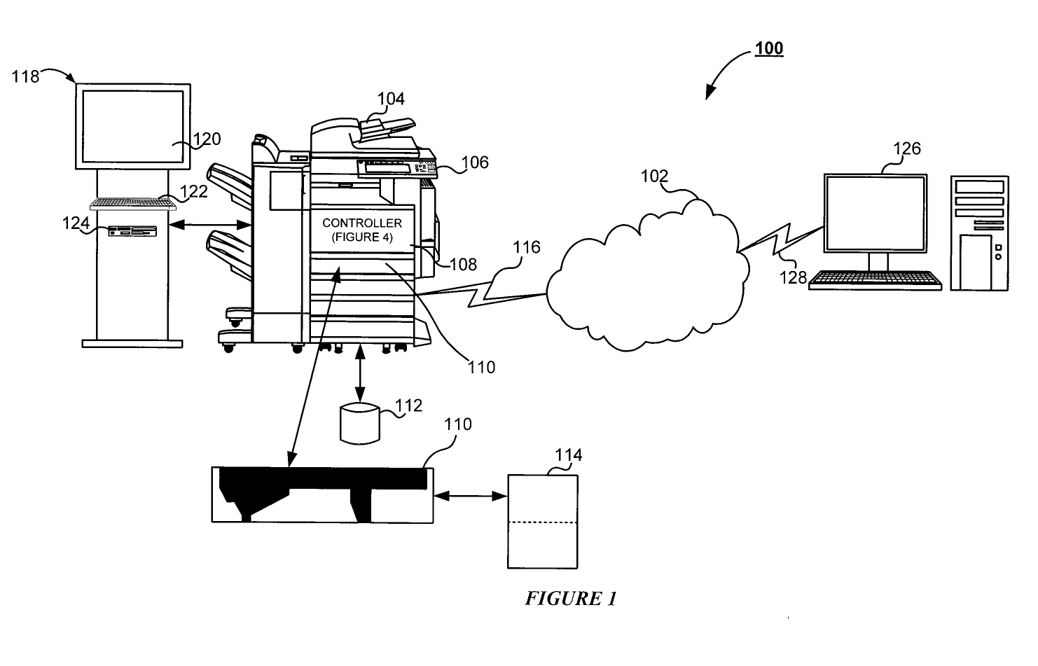

The subject application is directed to a system and method for improved data entry for electronic documents. In particular, the subject application is directed to a system and method for enhancing ease and accuracy with data entry in document processing kiosk environments, such as greeting card kiosks employing a touch screen interface. More particularly, the subject application is directed to a system and method wherein various data entry fields are sequentially used for receipt of user-specified information. It will become apparent to those skilled in the art that the system and method described herein are suitably adapted to a plurality of varying electronic fields employing data entry displays, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for generating a data entry display in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

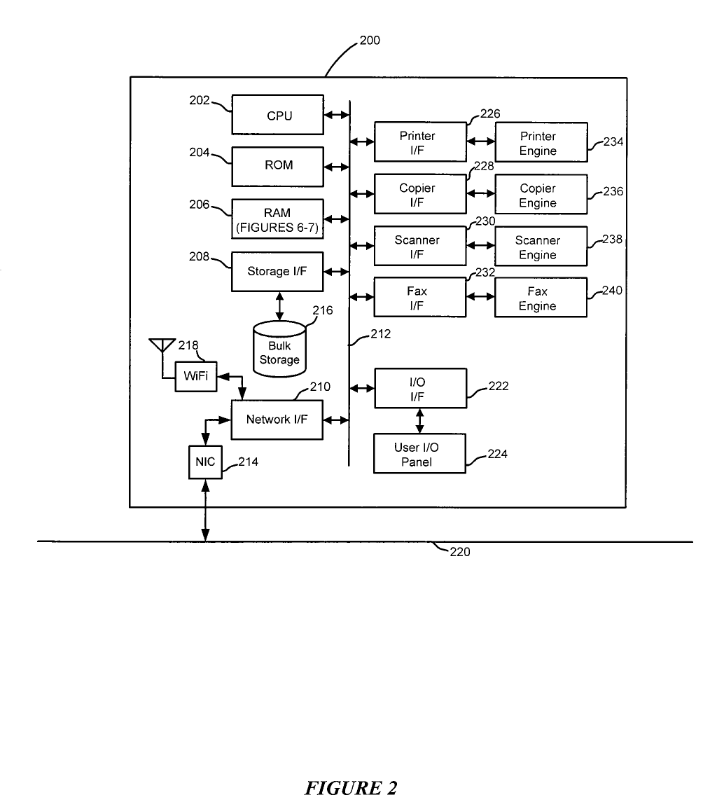

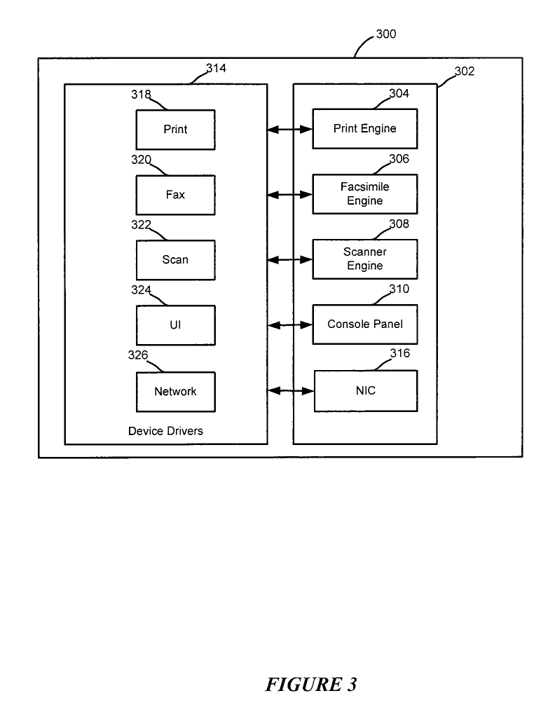

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like to an associated user, receive input from the associated user, and communicate the same to a backend component, such as a controller 108, as explained in greater detail below. Preferably, the document processing device 104 is communicatively coupled to the computer network 102 via a communications link 116. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

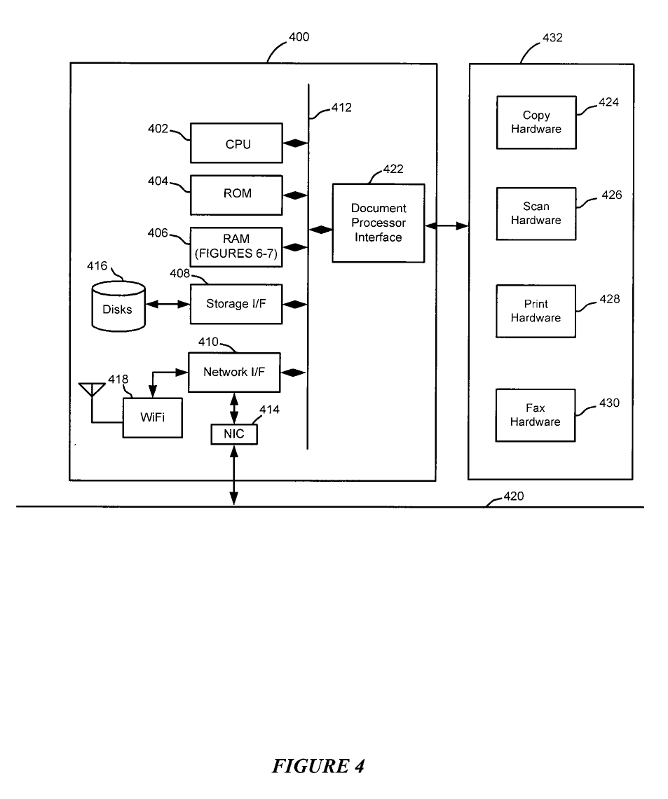

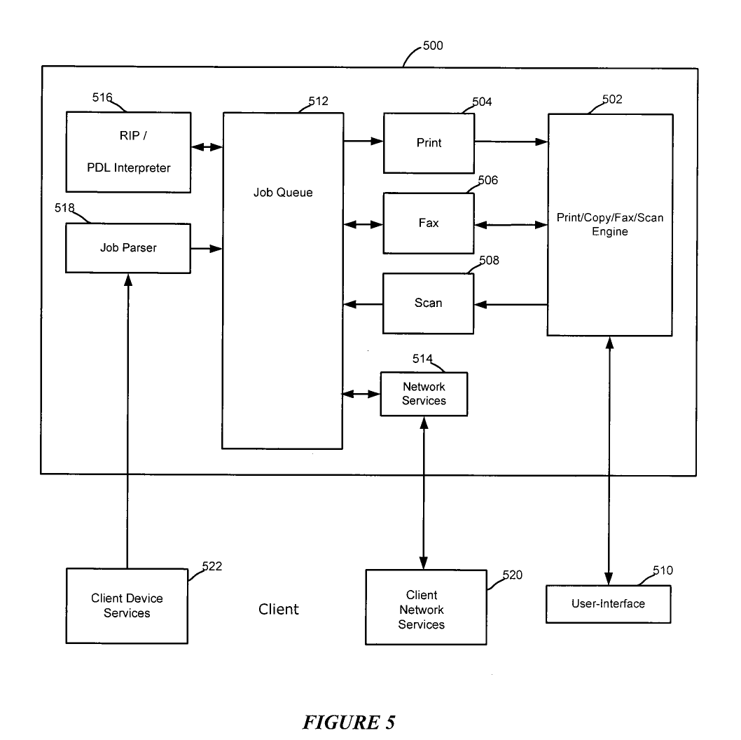

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system known in the art, and, thus, the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for generating a data entry display of the subject application. The functioning of the controller 108 will better be understood in conjunction with the block diagrams illustrated in FIGS. 4 and 5, explained in greater detail below.

Communicatively coupled to the document processing device 104 is a data storage device 112. In accordance with the preferred embodiment of the subject application, the data storage device 112 is any mass storage device known in the art, including, for example and without limitation, magnetic storage drives, hard disk drives, optical storage devices, flash memory devices, or any suitable combination thereof. In the preferred embodiment, the data storage device 112 is suitably adapted to store document data, image data, electronic database data, or the like. It will be appreciated by those skilled in the art that, while illustrated in FIG. 1 as being a separate component of the system 100, the data storage device 112 is capable of being implemented as an internal storage component of the associated document processing device 104, a component of the controller 108, or the like, such as, for example and without limitation, an internal hard disk drive or the like. In accordance with one embodiment of the subject application, the data storage device 112 is capable of storing images, greeting card template data, business card template data, form template data, multimedia data files, fonts, and the like.

As depicted in FIG. 1, the document processing device 104 further includes one or more media storage trays 110, suitably configured to stored output media 114 for output by the document processing device 104. The skilled artisan will appreciate that the media storage tray 110 is representative of any of a myriad of storage components associated with the document processing device 104 capable of storing sheets of paper of varying sizes, sheets of transparencies, blank greeting cards, blank multi-media, blank CD or DVD media, blank business cards, blank perforated media, photographic paper, envelopes, or any other tangible output medium upon which documents or images are rendered.

Illustrated in FIG. 1 is a kiosk 118 communicatively coupled to the document processing device 104 and, in effect, to the computer network 102. It will be appreciated by those skilled in the art that the kiosk 118 is capable of being implemented as a separate component of the document processing device 104 or as an integral component thereof. Use of the kiosk 118 in FIG. 1 is for example purposes only, and the skilled artisan will appreciate that the subject application is capable of implementation without the use of the kiosk 118. In accordance with one embodiment of the subject application, the kiosk 118 includes a display 120 and a user input device 122. As will be understood by those skilled in the art, the kiosk 118 is capable of implementing a combination user input device/display, such as a touch screen interface. According to one embodiment of the subject application, the kiosk 118 is suitably adapted to display prompts to an associated user, receive instructions from the associated user, receive payment data, receive selection data from the associated user, and the like. Preferably, the kiosk 118 includes a magnetic card reader, conventional bar code reader, or the like suitably adapted to receive and read payment data from a credit card, coupon, debit card, or the like. The system 100 of FIG. 1 also includes a portable storage device reader 124 coupled to the kiosk 118 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a user device 126 in data communication with the computer network 102 via a communications link 128. It will be appreciated by those skilled in the art that the user device 126 is shown in FIG. 1 as a computer workstation for illustration purposes only. As will be understood by those skilled in the art, the user device 126 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 128 is any suitable channel of data communications known in the art, including, but not limited to, wireless communications such as, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the user device 126 is suitably adapted to generate and transmit electronic documents, multimedia files, document processing instructions, user interface modifications, upgrades, updates, personalization data, or the like to the document processing device 104 or any other similar device coupled to the computer network 102. In accordance with one embodiment of the subject application, the user device 126 includes a thin client interface, such as a web browser application, suitably adapted to securely interact with the document processing device 104, the kiosk 118, or the like.

Turning now to FIG. 2, illustrated is a representative architecture of a suitable document processing device 200 (shown in FIG. 1 as the document processing device 104), on which operations of the subject system are completed. Included is a processor 202, suitably comprised of a central processor unit. However, it will be appreciated that the processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206, suitably formed of dynamic random access memory, static random access memory, or any other suitable, addressable memory system. The random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage, such as a disk, optical, tape drive, or the like, as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218 suitably adapted for wireless communication via means such as WiFi, WiMax, wireless modem, cellular network, or any suitable wireless communication system. It is to be appreciated however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Suitable executable instructions on the device 200 facilitate communication with a plurality of external devices such as workstations, document processing devices, other servers, or the like. While, during operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with bus 212 are interfaces to one or more document processing engines. In the illustrated embodiment, the printer interface 226, copier interface 228, scanner interface 230, and facsimile interface 232 facilitate communication with the printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300 (shown in FIG. 1 as the document processing device 104) for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302 that facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices so as to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402, suitably comprised of a central processor unit. However, it will be appreciated that processor 402 may advantageously be composed of multiple processors working in concert with one another, as will be appreciated by one of ordinary skill in the art. Also included is a non-volatile or read only memory 404, which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable, and writable memory system. The random access memory 406 provides a storage area for data instructions associated with applications and data handling accomplished by the processor 402.

A storage interface 408 suitably provides a mechanism for non-volatile, bulk, or long-term storage of data associated with the controller 400. The storage interface 408 suitably uses bulk storage, such as any suitable addressable or serial storage, such as a disk, optical, tape drive, or the like, as shown as 416, as well as any suitable storage medium, as will be appreciated by one of ordinary skill in the art.

A network interface subsystem 410 suitably routes input and output from an associated network, allowing the controller 400 to communicate with other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface card 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purpose document processing devices that are subsets of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter, or any suitable mechanism for interchange of an electronic document to a format better suited for interchange with device functions such as print 504, facsimile 506 or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

In operation, data entry template data is retrieved from an associated data storage. The generation of a data entry template is then commenced on an associated display in accordance with the retrieved template data. The data entry template includes at least one data entry field adapted to receive user-specified information. Each data entry field is then designated as an active field. A prompt is then generated on the associated display relating to content associated with each active field. An animation is then generated on an area associated with each active field. User specified-information is then received into each active field. Each active field is then updated such that user-specified information is displayed on the associated display.

In accordance with one example embodiment of the subject application, a document processing request corresponding to a data entry template is first received by the document processing device 104 from an associated user. It will be appreciated by those skilled in the art that the document processing device 104 is capable of receiving such a request via the user interface 106, the kiosk 118, or the like. Preferably, the controller 108 or other suitable component associated with the document processing device 104 facilitates the generation of a graphical user interface via the user interface 106, the display 120 associated with the document processing device 104, the user device 126, or the like. The skilled artisan will understand that the graphical user interface enables the user to select a desired document processing operation, input data receivable by the controller 108, review data displayed by the controller 108, and the like. Suitable examples of data entry template document processing requests include, for example and without limitation, greeting card output, business card output, calendar output, business form output, multimedia card output, gift card output, and other operations as will be understood by those skilled in the art inclusive of one or more fields for user-specified information.

Following receipt of the document processing request corresponding to data entry template processing, data entry template data is retrieved from the associated data storage device 112 by the controller 108 or other suitable component associated with the document processing device 104. According to one particular embodiment of the subject application, the template data is capable of being stored remotely from the document processing device 104/kiosk 118, such as, for example and without limitation, the user device 126, a network storage (not shown), a backend network server (not shown), or the like. The controller 108 or other suitable component associated with the document processing device 104 then generates a display of the retrieved data entry template data on an associated display, e.g., the user interface 106, the display 120, a thin client interface resident on the user device 126, or the like. It will be appreciated by those skilled in the art that the display of the retrieved template data corresponds, for example and without limitation, to the display of graphical representations of the template data to the user via a suitable graphical user interface, e.g., thumbnail images.

The associated user is then prompted to select a desired data entry template from among those displayed via the associated user interface 106, display 120, thin client, or the like. Selection data is received from the user via the touch screen display 120 or the user interface 106, is input via the thin client interface of the user device 126, or the like, corresponding to the user selection of a data entry template. The selected data entry template with associated data entry fields is then generated by the controller 108 or other suitable component associated with the document processing device 104 on an appropriate display, e.g., the user interface 106, the touch screen display 120, the thin client of the user device 126, or the like.

Following the selection of a desired data entry template, the controller 108 or other suitable component associated with the document processing device 104 determines an appropriate sequencing associated with the completion of the data entry fields of the selected data entry template. That is, the controller 108 determines, based upon the selected template, the order in which data entry fields are to be displayed and/or completed with user-specified information. For example, upon the selection of a greeting card template with data entry fields, the controller 108 determines the order for completion of the card caption, greeting text, closing, signature, and the like. The first data entry field in the sequence thereof is then designated as an active data entry field. A static border area is then generated by the controller 108 or other suitable component associated with the document processing device 104 for each inactive field displayed on the user interface 106, the touch screen display 120, the thin client of the user device 126, and the like.

An animation is then generated on the designated active data entry field on the display, illustrating the active status thereof. Suitable examples of such animation include, without limitation, blinking or flashing lines surrounding the data entry field, a graphical widget moving around the data entry field, blinking or flashing text associated with the field, or other suitable indicators, as will be known in the art. A prompt is then generated on the associated display, e.g., the user interface 106, the display 120, the thin client interface, or the like relative to content associated with the active field. The skilled artisan will appreciate that suitable information describing the active field includes, for example and without limitation, a description of types of data to be input, a description of example language, instructions for completing the data entry field, and the like.

The controller 102 or other suitable component associated with the document processing device then determines whether user-specified information has been received from the associated user. Preferably, the user is able to input text or other selections corresponding to completion of the data entry field via the user interface 106 associated with the document processing device 104, the touch screen display 120 or user input component 122 associated with the kiosk 118, the input devices of the user device 126, or the like. Thus, for example and without limitation, the user types, via a suitable hardware keyboard or touch screen graphics keyboard, data to be entered into the active field.

Upon a determination that no user-specified data has been input, the controller 108 or other suitable component associated with the document processing device updates the active field with a null value, indicating that the user desires the field to remain blank on any completed template output by the document processing device 104. For example, when the template selected corresponds to a greeting card, a card caption is capable of being left blank, thereby leaving the card without a card caption visible on the outside front of the greeting card. Thereafter, the pattern of sequencing of the fields is altered based upon the lack of user-specified information, and a determination is made whether, as a result of the alteration to the pattern of sequencing, any additional fields remain in the template for completion by the user.

Upon a determination that user-specified data has been received corresponding to the active field, the active field is suitably updated such that the received user-specified information is displayed in the field on the display, e.g., the user interface 106, the display 120, the thin client associated with the user device 126, or the like. The pattern of sequencing of fields is then altered in accordance with the received user input information. A determination is then made as to whether another field remains in the sequence for completion by the user.

When at least one additional field remains in the sequence for completion by the user, e.g., the inside of a greeting card still requires user-specified input, the next field in the sequence is designated as an active field. Thereafter, operations continue as set forth above, with the generation of static border areas on each inactive field and the generation of an animation associated with the now active field.

In the event that no additional fields remain for completion with user-specified information, a completed data entry template is generated by the controller 108 or other suitable component associated with the document processing device 104. In accordance with one embodiment of the subject application, the controller 108 or other suitable component associated with the document processing device 104 facilitates the display of a preview of the generated template on the user interface 106, the display 120, the thin client of the user device 126, or the like for user acceptance thereof.

When electronic output of the generated completed template has been selected by the user via user interactions with the graphical user interface 106, the controller 108 or other suitable component associated with the document processing device 104 receives output destination data from the associated user. The skilled artisan will appreciate that such destination data includes, for example and without limitation, recipient identification, recipient electronic mail address, facsimile number, storage location, or the like. Upon receipt of the output destination data from the user, the controller 108 or other suitable component associated with the document processing device 104 communicates the generated complete template to the selected recipient via the computer network 102. When electronic output is not selected by the user, e.g., a tangible output is desired, the document processing device 104, via facilitation by the controller 108, generates a tangible output corresponding to the completed data entry template on selected output media 114.

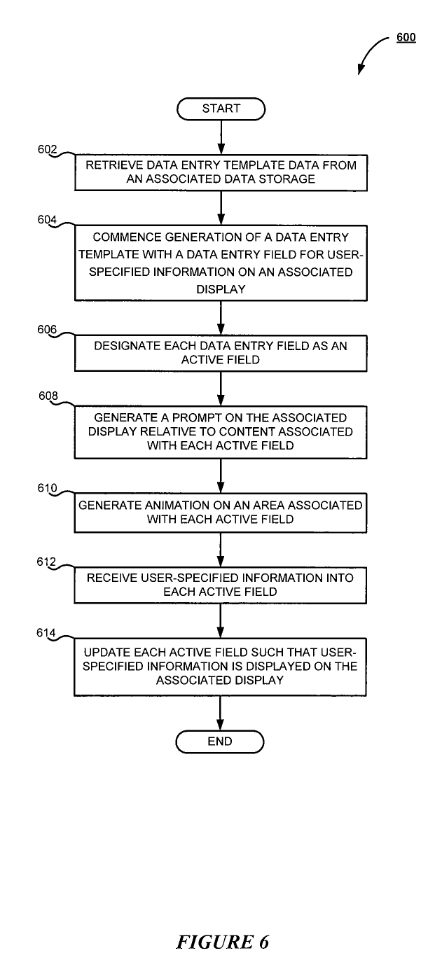

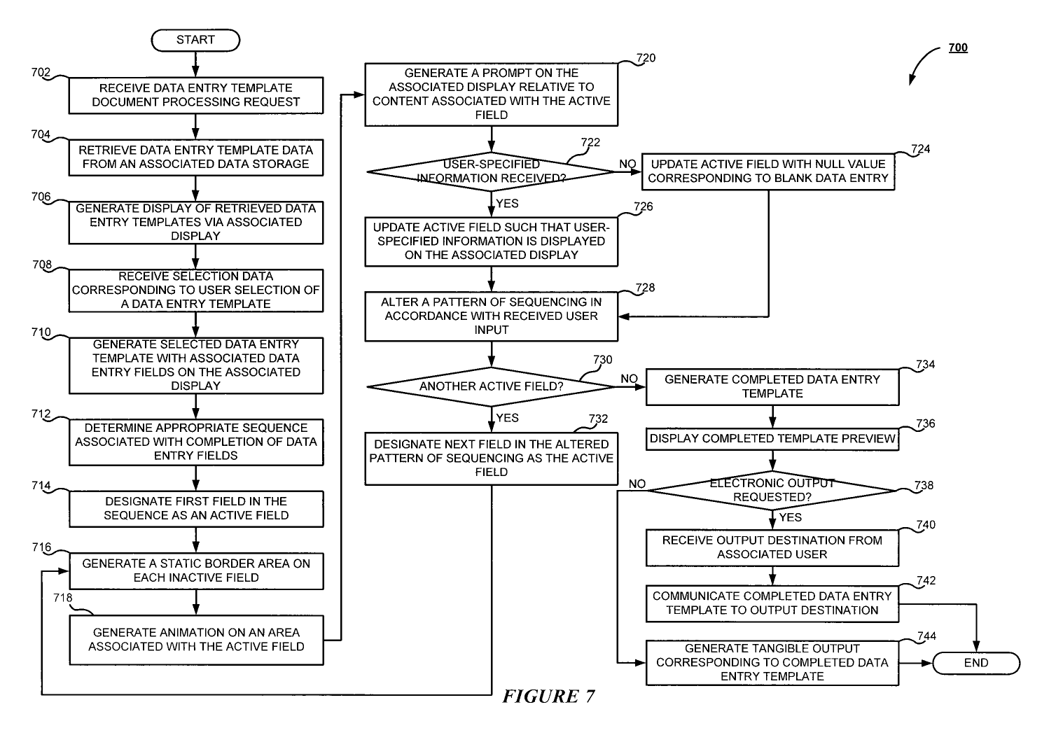

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for generating a data entry display in accordance with one embodiment of the subject application. Beginning at step 602, date entry template data is retrieved from an associated data storage device, such as the data storage device 112 associated with the document processing device 104.

Generation is then commenced at step 604 of a data entry template on an associated display in accordance with the retrieved template data. That is, the controller 108 or other suitable component associated with the document processing device 104 facilitates the generation of the retrieved template data on the user interface 106, the display 120, a thin client associated with the user device 126, and the like. In accordance with one embodiment of the subject application, each data entry template includes one or more data entry fields adapted to receive user-specified information.

Flow then progresses to step 606, whereupon each entry field associated with the retrieved data entry template data is then designated as an active field. The controller 108 or other suitable component association with the document processing device 104 then generates a prompt at step 608 on the associated display relating to content associated with each active field. Animation is then generated at step 610 on an area associated with each active field. User specified-information is then received into each active field at step 612. Preferably, user-specified information is received from the associated user via the user interface 106, the touch screen display 120, the thin client interface associated with the user device 126, or the like. At step 614, each active field is then updated such that user-specified information is displayed on the associated display.

Referring now to FIG. 7, there is shown a flowchart 700 illustrating a method for generating a data entry display in accordance with one embodiment of the subject application. The methodology depicted in FIG. 7 begins at step 702, whereupon a document processing device 104 receives a document processing request associated with a data entry template from an associated user. In accordance with one embodiment of the subject application, the controller 108 or other suitable component associated with the document processing device 104 facilitates the generation of a graphical user interface via the user interface 106, the display 120 associated with the document processing device 104, the user device 126, or the like, thereby enabling the user to select a desired document processing operation, input data receivable by the controller 108, review data displayed by the controller 108, and the like. The skilled artisan will appreciate that suitable data entry templates include, for example and without limitation, greeting card output, business card output, calendar output, business form output, multimedia card output, gift card output, and other operations as are known in the art inclusive of one or more data entry fields for user-specified information.

At step 704, the controller 108 or other suitable component associated with the document processing device 104 retrieves data entry template data from the associated data storage device 112. It will be appreciated by those skilled in the art that the data entry template data is capable of being retrieved by the controller 108 or other suitable component of the document processing device 104 via the computer network 102 from networked storage device, the user interface device 126, a network server, or the like, via the portable storage device reader 124 or the like. A display of the retrieved data entry template data is then generated on an associated display at step 706 by the controller 108 or other suitable component associated with the document processing device 104, e.g., generated via the user interface 106, the display 120, a thin client interface resident on the user device 126, or the like. A suitable example of such a display includes, for example and without limitation, graphical representations of the template data to the user via a suitable graphical user interface, such as thumbnail images.

At step 708, selection data corresponding to the user selection of a desired data entry template is received from the user via the user interface 106 or the touch screen display 120, input via the thin client interface of the user device 126, or the like. The selected data entry template is then generated by the controller 108 or other suitable component associated with the document processing device 104 at step 710 on an appropriate display, e.g., the user interface 106, the touch screen display 120, the thin client of the user device 126, or the like. In accordance with one embodiment of the subject application, the generated data entry template is generated with associated data entry fields displayed therewith.

An appropriate sequencing associated with the completion of the data entry fields of the selected data entry template is then determined at step 712 by the controller 108 or other suitable component associated with the document processing device 104. As stated above, for example, the controller 108 determines the order in which data entry fields are to be displayed and/or completed with user-specified information based upon the selected template. Continuing with the example embodiments discussed above, when the selected data entry template corresponds to a greeting card template with data entry fields, the order for completion of the card caption, greeting text, closing, signature, and the like is determined by the controller 108 at step 712.

The controller 108 or other suitable component associated with the document processing device 104 then designates the first data entry field in the sequence thereof as an active data entry field at step 714. Flow then proceeds to step 716, whereupon a static border area is generated on each inactive field of the associated data entry template displayed on the user interface 106, the touch screen display 120, the thin client of the user device 126, or the like.

The controller 108 or other suitable component associated with the document processing device then generates, at step 718, an animation on the designated active data entry field on the display, illustrating the active status thereof. Suitable examples of such animation include, without limitation, moving dashes, blinking lines, or flashing lines surrounding the data entry field; a graphical widget moving around the data entry field; blinking or flashing text associated with the field; or other suitable indicators, as will be known in the art. At step 720, a prompt is generated on the associated display relative to content associated with the active field, e.g., the user interface 106, the display 120, the thin client interface, or the like. The skilled artisan will appreciate that suitable information describing the active field includes, for example and without limitation, a description of types of data to be input, a description of example language, instructions for completing the data entry field, and the like.

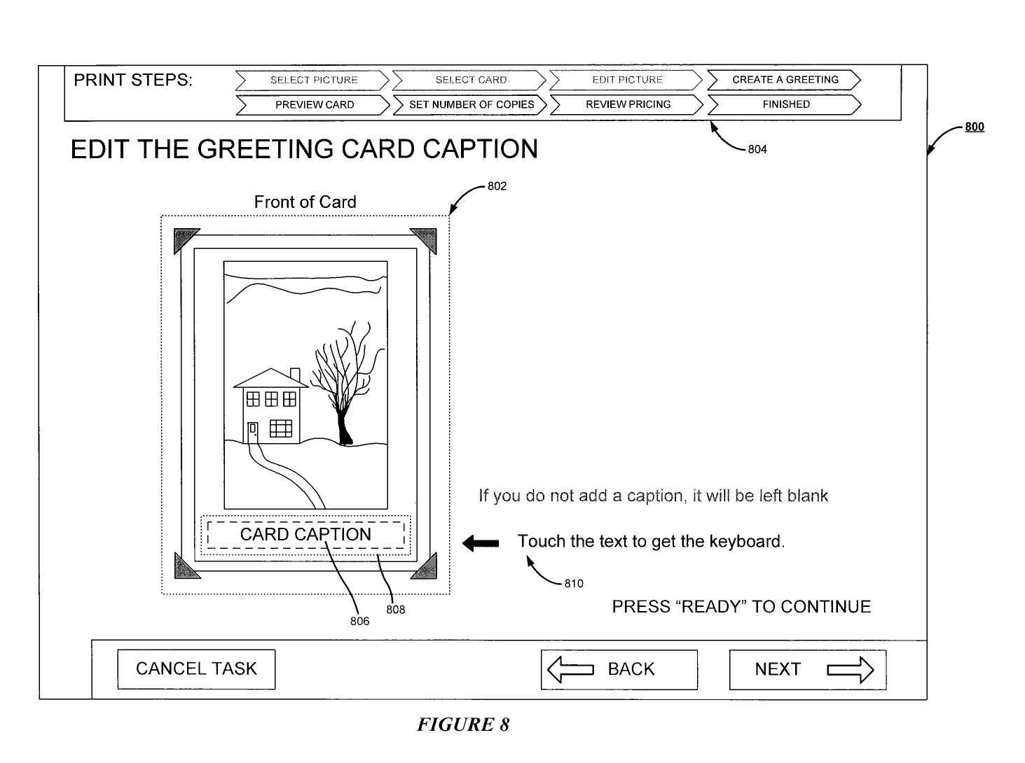

Turning now to FIG. 8, there is shown an example embodiment of a graphical user interface 800 of the subject application for data entry on a greeting card template. As shown in FIG. 8, the user interface 800 includes a plurality of graphical indicia displayed to the user and corresponding to the selected greeting card template 802, the progress of the greeting card production operation 804, a “card caption” active data entry field 806, an animation 808, and a prompt 810 associated with the active field 806. The skilled artisan will appreciate that the card template 802 represents the outside of the greeting card, containing a single data entry field 806 that is active.

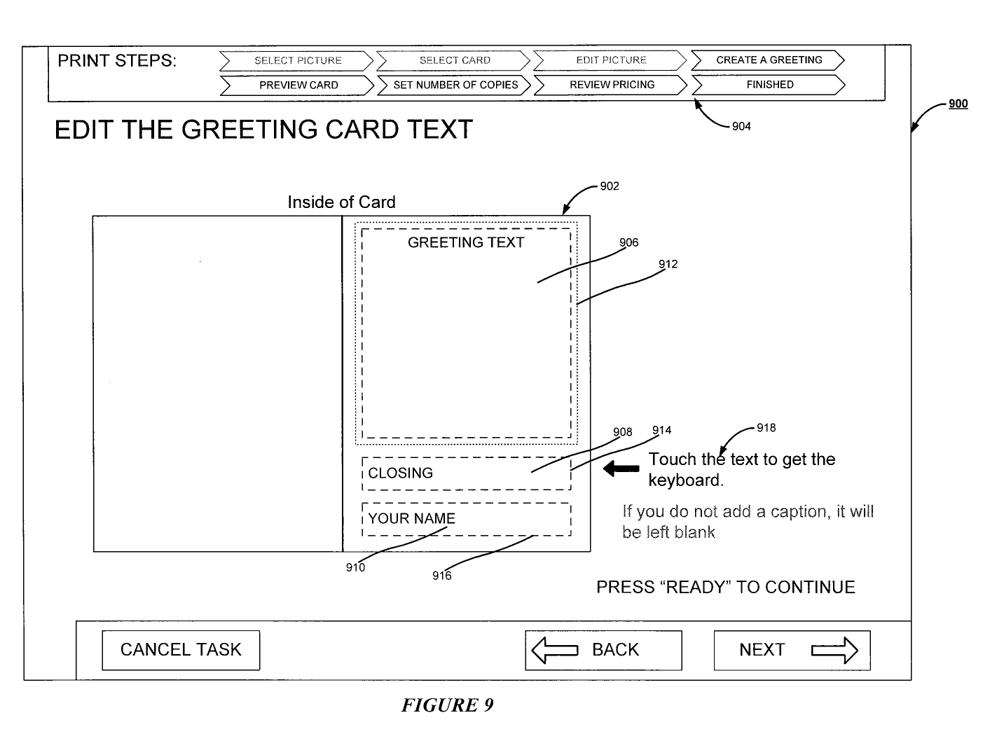

FIG. 9 illustrates another example embodiment of a graphical user interface 900 corresponding to the inside of the selected greeting card template 902 (the outside of which is shown in FIG. 8 at 802). As shown in FIG. 9, the user interface 900 includes the progress of the greeting card production operation 904, an active “greeting text” data entry field 906, an inactive “closing” data entry field 908, an inactive “your name” data entry field 910, an animation 912 indicating the active data entry field 906, a static border area 914 indicating the inactive date entry field 908, a static border area 916 indicating the inactive data entry field 910, and a prompt 918 associated with the active data entry field 906. Further operations of FIG. 7 will be discussed below with respect to FIG. 9.

Returning to FIG. 7, a determination is then made at step 722 as to whether user-specified information has been received from the associated user; that is, whether the user has input text or other input data corresponding to the completion of the active data entry field 906 via the user interface 106 associated with the document processing device 104, the touch screen display 120 or user input device 122 associated with the kiosk 118, the input devices of the user device 126, or the like. Thus, for example and without limitation, the user types, via a suitable hardware keyboard or touch screen graphics keyboard, data to be entered into the active field 906.

Upon a determination that user-specified data has not been input by the user at step 722, the controller 108 or other suitable component associated with the document processing device 104 updates the active field 906 at step 724 with a null value, indicating that the user desires the field 906 to remain blank on any completed template output by the document processing device 104. As shown in FIG. 9, the “greeting text” active data entry field 906 is capable of being left blank, for example, to allow the user to personally write a desired message thereon. Flow then proceeds to step 728, whereupon the pattern of sequencing of the fields is altered by the controller 108 or other suitable component associated with the document processing device 104 in accordance with the lack of user-specified information. A determination is then made at step 730 whether, as a result of the alteration to the pattern of sequencing, any additional fields remain in the template for completion by the user.

Returning to step 722, when it is determined that user-specified data has been received corresponding to the active field 906, flow proceeds to step 726, whereupon the active field 906 is suitably updated such that the received user-specified information is displayed in the field 906 on the display, e.g., the user interface 106, the display 120, the thin client associated with the user device 126, or the like. Flow then progresses to step 728, whereupon the pattern of sequencing of fields 906, 908, and 910 is altered in accordance with the received user input information. Operations then proceed to step 730 for a determination as to whether any additional fields remain in the altered sequence for completion by the user.

When at least one additional field remains in the sequence for completion by the user, e.g., the “closing” data entry field 908 of the greeting card template 902, the next field in the sequence is designated as an active field at step 732. That is, the “closing” data entry field 908 is designated as an active data entry field. Flow then returns to step 716, whereupon a static border area is generated on each inactive field, now the “greeting text” data entry field 906 (not shown) and the “your name” data entry field 910 (static border area 916). An animation (not shown) is thereafter generated at step 718 around the active “closing” data entry field 908, visually indicating the active status thereof. Operations continue, as set forth above, with the generation of a suitable prompt 918 at step 720 and the determination at step 722 with respect to the receipt of user-specified information.

Upon a determination at step 730 that no additional fields remain for completion with user-specified information, a completed data entry template is generated by the controller 108 or other suitable component associated with the document processing device 104 at step 734; that is, all fields 806, 906, 908, and 910 have been completed, and a template greeting card is generated by the controller 108 or other suitable component associated with the document processing device 104. The generated completed template is then displayed via the user interface 106, the display 120, the thin client of the user device 126, or the like, enabling the user to preview the template for acceptance thereof at step 736.

A determination is then made at step 738 whether an electronic output of the generated completed template has been selected by the user via user interactions with the graphical user interface 800 or 900. When electronic output has been selected by the user, flow proceeds to step 740, whereupon the controller 108 or other suitable component associated with the document processing device 104 receives output destination data from the associated user. The skilled artisan will appreciate that such destination data includes, for example and without limitation, recipient identification, recipient electronic mail address, facsimile number, storage location, or the like. The controller 108 or other suitable component associated with the document processing device 104 then communicates the generated complete template to the selected recipient via the computer network 102 at step 742. It will be appreciated by those skilled in the art that the generated template is also capable of being communicated to a suitable portable storage medium coupled to the document processing device 104, the kiosk portable storage device interface 124, or the like. When it is determined at step 738 that electronic output has not been selected by the user, e.g., a tangible output is desired, the document processing device 104, via facilitation by the controller 108, generates a tangible output corresponding to the completed data entry template on selected output media 114 at step 744.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program: for example, a storage medium such as ROM or RAM; optical recording media such as CD-ROM or magnetic recording media such as floppy discs; or any transmissible carrier such as an electrical or optical signal conveyed by electrical or optical cable, radio, or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for generating a data entry display comprising:
means adapted for retrieving data entry template data from an associated data storage;
template display means adapted for commencing generation of a data entry template on an associated display in accordance with retrieved template data, the data entry template having at least one data entry field adapted to receive user-specified information;
means adapted for designating each data entry field as an active field;
means adapted for generating a prompt on the associated display relative to content associated with each active field;
animation means adapted for generating an animation on an area associated with each active field;
means adapted for receiving user-specified information into each active field; and
means adapted for updating each active field such that user-specified information is displayed therein on the associated display.

2. The system of claim 1 wherein the designating means further comprises sequencing means adapted for sequentially designating each data entry field as an active field.

3. The system of claim 2 wherein the animation means includes means adapted for generating the animation on a border area associated with each active field.

4. The system of claim 3 wherein the template display means includes means adapted for generating a static border area on each inactive field, which static border area becomes animated when its corresponding field is designated active by the sequencing means.

5. The system of claim 4 wherein the border area is comprised of a perimeter formed as dashes, wherein positions of the dashes are periodically altered relative to each active field.

6. The system of claim 2 further comprising means adapted for prompting operation of the sequencing means in accordance with received user input.

7. The system of claim 2 further comprising means adapted for altering a pattern of sequencing by the sequencing means in accordance with received user input.

8. A method for generating a data entry display comprising the steps of:
retrieving data entry template data from an associated data storage;
commencing generation of a data entry template on an associated display in accordance with retrieved template data, the data entry template having at least one data entry field adapted to receive user-specified information;
designating each data entry field as an active field;
generating a prompt on the associated display relative to content associated with each active field;
generating an animation on an area associated with each active field;
receiving user-specified information into each active field; and
updating each active field such that user-specified information is displayed therein on the associated display.

9. The method of claim 8 wherein each data entry field is sequentially designated as an active field.

10. The method of claim 9 wherein the animation is generated on a border area associated with each active field.

11. The method of claim 10 further comprising the step of generating a static border area on each inactive field, which static border area becomes animated when its corresponding field is designated active.

12. The method of claim 11 wherein the border area is comprised of a perimeter formed as dashes, wherein positions of the dashes are periodically altered relative to each active field.

13. The method of claim 9 wherein the sequential designation of each data entry field is in accordance with received user input.

14. The method of claim 9 wherein the step of sequentially designating each data entry field includes altering a pattern of sequencing in accordance with received user input.

15. A computer-implemented method for generating a data entry display comprising the steps of:
retrieving data entry template data from an associated data storage;
commencing generation of a data entry template on an associated display in accordance with retrieved template data, the data entry template having at least one data entry field adapted to receive user-specified information;
designating each data entry field as an active field;
generating a prompt on the associated display relative to content associated with each active field;
generating an animation on an area associated with each active field;
receiving user-specified information into each active field; and
updating each active field such that user-specified information is displayed therein on the associated display.

16. The computer-implemented method of claim 15, wherein each data entry field is sequentially designated as an active field.

17. The computer-implemented method of claim 16 wherein the animation is generated on a border area associated with each active field.

18. The computer-implemented method of claim 17 further comprising the step of generating a static border area on each inactive field, which static border area becomes animated when its corresponding field is designated active.

19. The computer-implemented method of claim 18 wherein the border area is comprised of a perimeter formed as dashes, wherein positions of the dashes are periodically altered relative to each active field.

20. The computer-implemented method of claim 15 wherein the sequential designation of each data entry field is in accordance with received user input.

21. The computer-implemented method of claim 15 wherein the step of sequentially designating each data entry field includes altering a pattern of sequencing in accordance with received user input.
